(19) United States
(12) Patent Application Publication
(10) Pub. No.: US 2016/0224843 A1
(43) Pub. Date: Aug. 4, 2016

(54) METHOD FOR COUNTING PEOPLE

(71) Applicant: Zodiac Aerotechnics, Plaisir (FR)

(72) Inventor: Patrick Boigas, Jouars Ponchartrain (FR)

(21) Appl. No.: 15/012,963

(22) Filed: Feb. 2, 2016

(30) Foreign Application Priority Data
Feb. 2, 2015 (FR) 1550788

(51) Int. Cl. G06K 9/00; H04N 5/77; B64D 11/00; G06K 9/62

(52) U.S. Cl. CPC G06K 9/00778; G06K 9/6202; G06K 9/00255; G06K 9/00295; H04N 5/77; B64D 11/00

(57) ABSTRACT

A method for counting people passing through an access passage is based on the acquisition of a video stream by a camera. Such a method is particularly adapted to count the passengers entering the cabin of an aircraft during a phase of embarkation or disembarkation.

### CROSS REFERENCE TO RELATED APPLICATION

The present application claims the benefit of French Patent Application No. 1550788 filed Feb. 2, 2015, the contents of which are incorporated herein by reference in their entirety.

### TECHNICAL FIELD OF THE INVENTION

The present invention relates to a method and a system for counting people.

Many situations require the counting of people accessing a place, for example for statistical studies of attendance or safety conditions.

### BACKGROUND OF THE INVENTION

Usually, such counting is carried out by a dedicated operator, who can be provided with a mechanically actuated counter in order to reduce the risk of a counting error.

A purpose of the present invention is to carry out such counting of people automatically, without making use of an operator when the people are passing.

An additional purpose is to allow subsequent display of the people counted, for example for the purpose of verification, or for purposes of investigation, checking, or searching for individuals.

### SUMMARY OF THE INVENTION

To this end, a first aspect of the invention proposes a method for counting people passing through an access passage, comprising the following steps:
/1/ having at least one camera arranged so that an optical field of the camera contains the access passage;
/2/ acquiring a video stream of images using the camera, continuously between a time when counting starts and a time when counting stops;
/3/ based on a comparison between several successive images of the video stream, detecting at least one appearance or disappearance of a face or human silhouette within the optical field; and
/4/ incrementing or decrementing a people count if an appearance or disappearance of a face or human silhouette has been detected in step /3/.

Such a method is simple and inexpensive to implement. Moreover, it does not make use of an operator during the counting period.

The access passage may be in particular an access passage to a means of transport, in particular an access passage to an aircraft cabin. The method is then intended for implementation during a phase of embarkation or disembarkation of passengers.

In certain implementations of the invention, the appearance or disappearance of a face or human silhouette may be detected in step /3/ based on a comparison between respective contents of the successive images, that are situated at least one predetermined edge of the optical field. In this case, step /3/ may comprise a distinction between detection of an appearance and detection of a disappearance, for the face or human silhouette within the optical field, this distinction being based on determination of a direction of movement of the face or human silhouette in the successive images at the predetermined edge of the optical field. Step /4/ may then be incrementing or decrementing the people count, based on whether the distinction has determined detection of an appearance or detection of a disappearance of the face or human silhouette within the optical field.

In improvements of the invention, at least some of the images of the video stream may also be processed in order to link masking or blurring to a location in these images of each face or human silhouette. Thus, the face or human silhouette can appear masked or blurred during subsequent display of the recorded images unless, before the display, it has been positively checked that display without blurring or masking is authorized. In this way, obligations to respect private life and individual image rights can be met. At the same time, the recording of the video stream containing the faces of the people who have passed through the access passage remain available for authorized agents, in particular for the purpose of verification, or for purposes of investigation, checking or searching for individuals.

In certain implementations of the invention, several distinct access passages may be respectively equipped with cameras, and steps /1/ to /3/ are carried out separately for each of the access passages. However, step /4/ may be carried out for a single people count, which is common to the distinct access passages. Such implementations are adapted in particular when several access passages in parallel serve the same site, such as a building open to the public or an aircraft cabin. The single and common count then constitutes a statement of the people who are inside this site.

A second aspect of the invention proposes a video people counting system, which comprises:
a camera, which is adapted to capture a video stream of images continuously between a time when counting starts and a time when counting stops;
a face or human silhouette recognition unit, which is adapted to search for at least one face or human silhouette inside each image;
an appearance or disappearance detection unit, which is adapted to detect a change, in terms of appearance or disappearance, for each face or human silhouette found by the searching unit, based on a comparison between respective contents of several successive images; and
a counter, which is actuated to increment or decrement a people count in accordance with an appearance or disappearance detection signal produced by the detection unit.

Such a system is adapted to implement a method according to the first aspect of the invention.

In order to implement the improvements to the invention which have been mentioned for the first aspect, in particular, the video counting system may also comprise:
a video recorder, which is adapted to record at least some of the images captured by the camera;
a blurring or masking unit, which is adapted to link blurring or masking to each location in the recorded images where a face or human silhouette is located; and
an authorization checking unit, which is adapted to send to a display screen the images processed by the blurring or masking unit, so that each face or human silhouette appears blurred or masked during display of these images on the display screen, unless it has been positively checked by this authorization control unit that display without blurring or masking is authorized.

Advantageously, the at least one of the elements of the video people counting system, among the camera, the face or human silhouette recognition unit, the appearance or disappearance detection unit, and the counter, may be shared with a cabin video monitoring system which is adapted for installation inside an aircraft.

Possibly, the video people counting system of the invention may also comprise an electrical energy supply terminal, the latter being adapted for connection to an energy source which is external to the system itself.

Possibly also, the video people counting system of the invention may also comprise a data transfer port, this data transfer port being adapted for connection to a display unit which is external to the system itself.

### BRIEF DESCRIPTION OF THE DRAWINGS

Other features and advantages of the present invention will become apparent from the following description of a non-limitative embodiment example, with reference to the attached drawings, in which:

FIG. 1 is an elevation view of an interior plan of an aircraft;

FIG. 2 reproduces several successive images of a video stream, showing the entry of a passenger into the aircraft of FIG. 1; and

FIG. 3 shows a sequence of image acquisition and processing modules, which is adapted to implement the invention.

For clarity sake, the dimensions of the elements represented in these figures do not correspond either to actual dimensions or to actual dimensional relationships. Moreover, identical references that are given in different figures denote identical elements, or elements with identical functions.

### DETAILED DESCRIPTION OF THE INVENTION

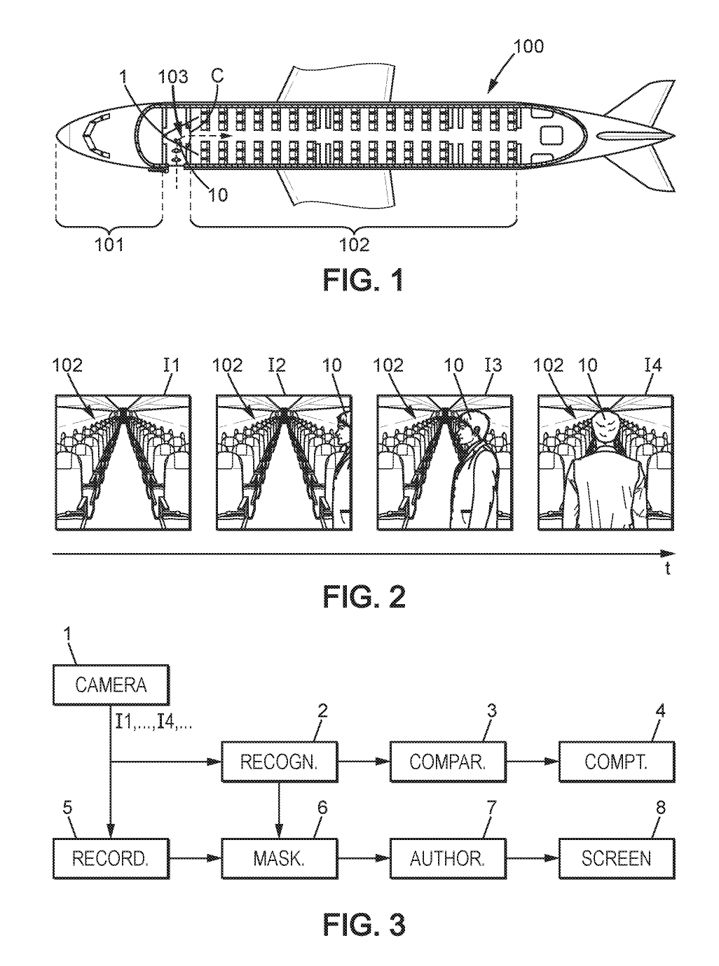

By way of example, FIG. 1 shows the access passage to the cabin of a passenger transport aircraft. The references 100, 101, 102 and 103 respectively denote the entire aircraft, its cockpit, the cabin in which the rows of seats intended for passengers are situated, and the access passage of the passengers from the outside of the aircraft to the inside of the cabin. The access passage 103, which is represented by a dashed-line arrow, can pass through an entrance area situated between the cockpit 101 and the cabin 102. FIG. 1 shows a passenger referenced 10, who is moving forward inside the entrance area to enter the cabin 102. The passenger 10 is therefore following the access passage 103.

According to the invention, a camera 1 is fixed inside the aircraft 100, so that its optical field C contains a cross-section of the access passage 103. Thus, the passenger 10 appears in the images of a continuous video stream captured by the camera 1. For example, the camera 1 may be situated above the door intermediate between the cockpit 101 and the entrance area of the aircraft 100.

The camera 1 may be adapted to capture images in the visible spectral range, or in the infrared spectral range, or even in the thermal infrared spectral range. Optionally, it may be adapted to capture spectral images in several of these spectral ranges simultaneously, and combination images are then constructed, resulting from combinations of several spectral images that have been captured simultaneously by the camera 1. The use of such combination or multispectral images makes it possible in particular to reduce a probability of false detection of people while retaining natural colour information.

FIG. 2 reproduces four successive images I1, I2, I3 and I4 as captured by the camera 1. In this figure, the horizontal axis which is marked t represents time. The image I1 is captured before the passenger 10 enters the optical field C, the image I2 is captured at the time when he enters the optical field C, the image I3 when the passenger 10 has moved forward into the optical field C, then the image I4 when he enters the cabin 102.

The appearance of the passenger 10 between images I1 and I2 can be detected by comparing the respective contents of the two images, in particular in an area which is limited to the proximity of the right-hand edge of these images. Movement detection can be used, but the combination of movement detection with shape recognition makes it possible to reduce the risk of false detection of a human being. To this end, a face or human silhouette recognition which proceeds by searching for characteristic points, may advantageously be implemented on the mobile elements contained in the images, in order to detect the appearance of the passenger 10 in the access passage 103. Software capable of carrying out such face recognition by characteristic points, is known to a person skilled in the art. A counter may then be incremented by one unit, to count the passengers who have passed through the access passage 103 in the direction of the cabin 102.

It is possible that a passenger comes back out of the cabin 102 to the outside of the aircraft 100, during the counting period. In this case, such a passenger appears with a direction of movement that is reversed within the optical field C of the camera 1. A detection of the direction of movement of the passenger 10 in successive images of the video stream makes it possible to distinguish between a movement of entry into the aircraft 100 or exit to the outside. In a manner that can be simply implemented, the direction of movement of the passenger 10 can be determined by comparing the positions of mobile elements contained in the images, in particular in proximity to the right-hand edge of these images. The passenger counter can then be incremented by one unit in the case of a movement in the direction of the entry into the aircraft 100, and decremented by one unit in the case of a movement in the direction of the exit to the outside of the aircraft 100.

The complete video stream captured by the camera 1 during embarkation may be subsequently viewed by an agent, for example for a purpose of verification. It is then possible that the distinct appearance of the face of each passenger 10 is not desired, in particular because of the legislation of certain countries. In this case, the video stream may be viewed on a screen with blurring or masking at the location of the face of each passenger in the images. The location of the face in each image may be determined by a unit searching for one of the characteristic points of a human face, and the blurring or masking is introduced locally at this location in the image during a step prior to display on the screen. Such an operation of blurring or masking of the faces may be implemented by default for any display of the video stream. Optionally, it may be inhibited when an authorization for display with the faces appearing distinctly, is produced by the display agent.

FIG. 3 shows a combination of image acquisition and processing modules, which is adapted to implement the invention. The reference numbers given in this figure have the following meanings:

1 camera already introduced

2 face or human silhouette recognition unit, marked RECOGN., for successively processing each image captured by the camera 1

3 image content comparison unit, marked COMPAR., for detecting a new appearance or disappearance of a face or human silhouette in the optical field C of the camera 1

4 counter, marked COUNT. and activated for incrementing or decrementing in accordance with a detection signal which is delivered by the image content comparison unit 3

5 recording unit, marked RECORD., for recording the images captured by the camera 1

6 blurring or masking unit, marked MASK., for introducing blurring or masking at the locations of the faces of the passengers in the recorded images, as these locations have been identified by the face recognition unit 2

7 authorization control unit, marked AUTHOR., for sending the images with blurring or masking on the faces of the passengers in the absence of an authorization display which is valid, or without blurring or masking when a valid authorization is introduced into the control unit 7

8 image display screen, marked SCREEN

Generally, but particularly when the invention is used onboard an aircraft, certain elements of the video people counting system may be shared with a cabin video monitoring system (denoted by the acronym CVMS) as already used in some aircraft, and described for example in the patent U.S. Pat. No. 8,127,333.

Furthermore, an electrical energy supply terminal for supplying the power necessary for the operation of at least some of the elements of the video people counting system, may be provided for connection to a power source external to the aircraft. Thus, the video people counting system can be used when the aircraft is on the apron during the embarkation or disembarkation phases, without causing excessive power consumption with respect to the capacity of the independent electricity generation system of the aircraft which is then activated.

Finally, the video people counting system may be equipped with a data transfer port, which is intended for connection to a display unit that is external to the aircraft. In this way, the images captured by the camera can also be accessed by an authorized agent, from a station situated outside the aircraft. Such a possibility of display from outside the aircraft may be useful for purposes of security or managing the embarkation or disembarkation of the passengers.

It is understood that the invention can be reproduced while modifying some secondary aspects thereof with respect to the detailed description that has just been given. In particular, the camera 1 may be oriented in different ways with respect to the access passage 103. In particular, it can be oriented so that the faces of the passengers appear face-on in the images at least one time during their presence in the optical field C of the camera 1. The camera 1 may be oriented so that the faces thus appear face-on during the entry of the passengers into the cabin 102 of the aircraft 100, or alternatively during their exit. Optionally, several cameras may be used simultaneously, while being oriented differently from each other in order together to cover an entire section of the access passage 103. Finally, the invention is not limited to the implementation of algorithms for detecting the appearance or disappearance of image contents, which are based on analysis of the images in proximity to one or more of the edges thereof. Similarly, the invention may be implemented without necessarily using face or human silhouette recognition algorithms. Indeed, the detection and analysis of the direction of the movements which occur in the optical field C of the camera 1 alone, based on the images that are acquired successively, can be sufficient for counting the people according to the invention.

Moreover, the invention can also be applied to an aircraft the cabin of which can be accessed by several entries, through each of which the passengers can enter or leave the cabin. Such case happens, for example, for an aircraft which the passengers can enter not only by a door situated close to the cockpit, but also by a door in the tail of the aircraft and/or by an intermediate door in the length of the cabin. It can also be applied identically to an aircraft with two cabin levels, or two decks, in which each deck is served by separate accesses. In such cases of cabins with multiple accesses, a camera is arranged at each of the accesses, and the passenger counter, common to all the accesses, is incremented or decremented in accordance with the faces or human silhouettes that are detected in the video stream of all the cameras, and changes in appearance or disappearance that are determined for each of these faces or human silhouettes.

Finally the invention can also be used advantageously to access the cargo hold of an aircraft, in particular to guarantee that nobody remains shut therein when it is closed.

1. Method for counting people passing through an access passage, comprising the following steps:
/1/ having at least one camera arranged so that an optical field of the camera contains the access passage;
/2/ acquiring a video stream of images using said camera, continuously between a time when counting starts and a time when counting stops;
/3/ based on a comparison between several successive images of the video stream, detecting at least one appearance or disappearance of a face or human silhouette within the optical field; and
/4/ incrementing or decrementing a people count if an appearance or disappearance of a face or human silhouette has been detected in step /3/.

2. Method according to claim 1, wherein the access passage is an access passage to a means of transport, in particular an access passage to an aircraft cabin, and the method is implemented during a phase of embarkation or disembarkation of passengers.

3. Method according to claim 1, wherein the appearance or disappearance of the face or human silhouette is detected in step /3/ based on a comparison between respective contents of the successive images, that are situated at least one predetermined edge of the optical field.

4. Method according to claim 3, wherein step /3/ comprises a distinction between detection of an appearance and detection of a disappearance, for the face or human silhouette within the optical field, said distinction being based on a determination of a direction of movement of said face or said human silhouette in the successive images at said predetermined edge of the optical field; and step /4/ is incrementing or decrementing the people count, based on whether the distinction has determined detection of an appearance or detection of a disappearance for said face or said human silhouette within the optical field.

5. Method according to claim 1, wherein at least some of the images of the video stream are moreover processed in order to link masking or blurring to a location in said images of each face or human silhouette, so that said face or said human silhouette appears masked or blurred during subsequent display of the recorded images, unless, before the display, it has been positively checked that display without blurring or masking is authorized.

6. Method according to claim 1, according to which several distinct access passages are respectively equipped with cameras, and steps /1/ to /3/are carried out separately for each of said access passages, and step /4/ is carried out for a single people count, common to the distinct access passages.

7. Video people counting system, comprising:
a camera adapted to continuously capture a video stream of images, between a time when counting starts and a time when counting ends;
a face or human silhouette recognition unit, adapted to search for at least one face or human silhouette inside each image;
an appearance or disappearance detection unit, adapted to detect a change, in terms of appearance or disappearance, for each face or human silhouette which has been found by the recognition unit, based on a comparison between respective contents of several successive images; and
a counter, actuated for incrementing or decrementing a people count in accordance with an appearance or disappearance detection signal, produced by the detection unit.

8. Video people counting system according to claim 7, adapted to implement a method for counting people passing through an access passage, which method comprises the following steps:
/1/ having at least one camera arranged so that an optical field of the camera contains the access passage;
/2/ acquiring a video stream of images using said camera, continuously between a time when counting starts and a time when counting stops;
/3/ based on a comparison between several successive images of the video stream, detecting at least one appearance or disappearance of a face or human silhouette within the optical field; and
/4/ incrementing or decrementing a people count if an appearance or disappearance of a face or human silhouette has been detected in step /3/.

9. Video people counting system according to claim 7, also comprising:
a video recorder, adapted to record at least some of the images captured by the camera;
a blurring or masking unit, adapted to link blurring or masking to each location in the recorded images, where a face or human silhouette is to be found;
an authorization control unit, adapted to send to a display screen the images processed by the blurring or masking unit, so that each face or human silhouette appears blurred or masked during display of said images on the display screen, unless it has been positively checked by this authorization control unit that display without blurring or masking is authorized.

10. Video people counting system according to claim 7, in which at least one, among the camera, the face or human silhouette recognition unit, the appearance or disappearance detection unit, and the counter is shared with a cabin video monitoring system adapted for installation inside an aircraft.

11. Video people counting system according to claim 7, comprising an electrical energy supply terminal, adapted for connection to a source of energy external to said video people counting system.

12. Video people counting system according to claim 7, comprising a data transfer port adapted for connection to a display unit external to said video people counting system.
